(19) United States
(12) Patent Application Publication
(10) Pub. No.: US 2008/0040075 A1
(43) Pub. Date: Feb. 14, 2008

(54) System, Method And Software Program For Managing, Documenting And Analyzing Water Damage Restoration Procedures

(76) Inventor: William Craig Fillmann, York, ME (US)

Correspondence Address: Brian M. Dingman;Mirick, O'Connell, DeMallie & Lougee, LLP, 1700 West Park Drive, Westborough, MA, 01581, US

(21) Appl. No.: 11/836,929

(22) Filed: Aug. 10, 2007

Related U.S. Application Data
(60) Provisional application No. 60/822,111, filed on Aug. 11, 2006.

(51) Int. Cl. G06F 15/00

(52) U.S. Cl. 702/187

(57) ABSTRACT

A computer-based system, and a computer readable program for use in a computer, for managing a drying procedure performed at a structure. A graphical user interface displays data input forms that when completed by the user record information relating to the structure, including data that establishes the locations in which drying is needed, the amount and types of drying equipment used to accomplish the drying procedure, periodic moisture content levels in the locations being dried, and the labor used in the drying procedure. The user can add forms, modify the forms, and use less than all of the forms. The entered data is saved in a computer memory. Reports are generated that include the entered data as well as data establishing the progress of drying over time, and include moisture standards that should be met before the job is completed. Real time management and analysis from the server database is available for management by insurance adjusters, insurance agents, network managers, contractors with multiple offices, contractors with a single office and multiple project managers, and/or others. Water damage restoration analysis from the server database can provide cost and procedural information for losses by structure, type, region, and extent of loss.

### CROSS REFERENCE TO RELATED APPLICATION

This application is based upon and claims the benefit of priority from U.S. provisional application No. 60/822,111 filed Aug. 11, 2006, the entire contents of which are incorporated by reference herein.

### FIELD OF THE INVENTION

This invention relates generally to the field of managing and analyzing water damage restoration projects. More specifically, the invention relates to systems and methods for managing, reporting, and analyzing multiple phases of a water damage restoration project, using a multi-step, customizable work plan and that employs industry-standard specifications and a database for developing detailed analyses.

### BACKGROUND OF THE INVENTION

Water damage restoration is the process of drying residential, commercial and industrial structures and properties, restoring them to pre-loss condition after sustaining any level of water or moisture damage. In the past, water damage restoration was limited to various inconsistent procedures including wet-vacuuming water from affected areas, opening windows to allow natural air drying, and arbitrarily applying dehumidifiers and air movers, to accelerate the drying process. Today, the industry uses advanced equipment, such as specially designed refrigerant and desiccant dehumidifiers, temporary heaters, air movers and air scrubbers, using a variety of application methods to accomplish the same task.

One recognized standards body, the Institute of Inspection, Cleaning and Restoration Certification (IICRC) has published a procedural standard, Standard and Reference Guide for Professional Water Damage Restoration, IICRC S500. The IICRC S500 describes the procedures to be followed, the precautions to be taken, and the documentation required to properly report conditions. Currently when procedures are implemented, they are often done in a piecemeal, non-standardized, non-repeatable manner despite the existence and recognition of the standard. These data are used for quick reference without regard to trending, application of equipment, or reference to the drying and restoration data collected and experience at other similar projects. Many service providers have not implemented or understood these procedures, failing to take other drying factors into account, and properly notifying other parties as to the extent of conditions. For example, property owners and their insurance carriers require information on standard procedures, application of resources, and the tracking of the work process. Further, service providers, property owners, property managers and insurance carriers would benefit from the ability to analyze historical data from multiple jobs.

Therefore, there is a need in the art for systems and methods for managing, reporting, and analyzing multiple phases of a water damage restoration project, using a multi-step, customizable work plan, employing industry-standard specifications for application of equipment, reporting, and analyzing the effectiveness of the drying process.

### SUMMARY OF THE INVENTION

This invention comprises a software-based, internet-enabled method of mapping and documenting the water damage drying process to be used by water damage professionals, insurance companies, property managers and homeowners. The software guides the user through a sequenced work plan to assure the water damage professional is meeting industry accepted standard drying procedures. This method includes the collection of data manually using a program generated paper form collection system, remotely using monitoring based on electronic systems (e.g., Radio Frequency Identification (RFID) systems, UPC, and others), web based data collection system automatically feeding the data, and the manual entry of moisture mapping points, moisture content of materials, environmental conditions, labor, and materials required during the water damage drying process, necessary to achieve acceptable results as per the accepted standards.

The method includes a comprehensive report of the water damage job upon completion of the project. This report documents conditions prior to, during and upon completion of the water damage project. Water damage professionals, insurance companies, and homeowners use this report.

The process also includes the development of unique business metrics, which compares the drying process against other water damage jobs, and will define industry standards for the application of equipment and processes that are effective in the market.

The present invention features a computer-based, web based system, and a computer readable software program, to manage a drying procedure performed by the water damage restoration contractor at a structure or property. The invention includes instructions to provide a graphical user interface to display data input forms that when completed record information relating to the structure that establishes the locations in which drying is needed, the amount and types of drying equipment required to accomplish the drying procedure, periodic moisture content levels in the locations being dried, and the labor and equipment used in the drying procedure. The data entered through the forms, and/or collected remotely from sensing devices, is saved in a computer memory.

The data input forms when completed may further record a description of the water damage and its cause, and may further record images of the structure. The images of the structure may be selected from the group of image types including scanned electronic images, photographs, and images drawn by a user. The electronic images may include a schematic diagram. The data input forms when completed may further record equipment and labor charges as related specifically to the drying process. The computer readable program may further contain instructions to allow a user to modify the data input forms to meet the peculiarities of the specific job within industry standards. The data input forms when completed may further record atmospheric conditions inside and outside of the structure including temperature and humidity, automatically computing-grains of water vapor per pound of dry air (GPP), an absolute measurement of the moisture both inside and outside of the drying chamber. These atmospheric conditions are referred to as psychrometric conditions. The relationship of these conditions is established in a psychrometric chart, or through established algorithms. The GPP further defines the vapor pressure of the environment, and it is the differential in the vapor pressure of the surrounding air with the vapor pressure of the material that affects the rate of drying. Moisture travels from areas of high vapor pressure, to areas of low vapor pressure, thus creating the drying model. The greater the difference in moisture vapor pressure between the water damaged material and the surrounding environment, the greater the rate of drying. The moisture levels in the location being dried may include the moisture content as wood moisture equivalent on instruments designed to record the moisture content of the water damaged material, with a higher level of moisture content creating a higher vapor pressure in the material.

The types and combination of drying equipment may be selected from the available restoration contractor's inventory or from rental businesses that provide such equipment, including dehumidifiers, temporary heaters, air movers, and air scrubbers. The computer readable program may further calculate application procedures and comprise instructions for the computer to communicate over a computer network the optimal procedures for the water damage restoration contractor to manage and analyze the project. The computer readable program may further comprise instructions to compare a completed drying project to standard procedures and other completed drying projects. Specifically, drying curves, moisture content of materials, application of equipment and resources are displayed and analyzed for further analysis of the project. This information is displayed in graphical format generated from collected data. The comparison is displayed as a daily relationship between outside psychrometric condition, inside psychrometric conditions, moisture content conditions, material drying equipment applied, labor applied, materials used, and travel costs of labor applied.

The computer readable program may further comprise instructions to generate a report that includes the periodic numeric moisture levels of materials, along with a graph representing rates of drying as compared with the application of resources. The graph of periodic moisture levels may include a standard moisture level for the location being dried.

### BRIEF DESCRIPTION OF THE DRAWINGS

Other objects, features and advantages will occur to those skilled in the art from the following description of the preferred embodiments and the accompanying drawings, in which:

FIG. 1 is a simplified schematic block diagram of a system for accomplishing the invention;

FIG. 2 is a simplified schematic block diagram of a client computer of FIG. 1;

FIG. 3 is a simplified schematic block diagram of the server computer of FIG. 1;

FIG. 4 is a block diagram of the preferred embodiment of the system of the invention; and

FIG. 5 is a flow chart of the preferred methodology of the invention, managed by an application computer program.

### DESCRIPTION OF PREFERRED EMBODIMENTS

The present invention provides methods and systems for managing, reporting, and analyzing multiple phases of a water damage restoration project, using a multi-step, customizable work plan and industry-standard specifications. In a preferred embodiment, a web-based user interface is used to enter, update and report project information.

This invention features a web-based process management computer program and business management system for water damage moisture mapping, establishing moisture mapping business intelligence and reporting conditions prior to, during and upon conclusion of the water damage restoration project.

A major problem in the water damage market is that there are no standards for managing a water damage remediation job, despite the standards for the achievement of results. The invention comprises a software program that defines a repeatable process with a format for documenting moisture content as required by industry standards. A standard format is provided for recording moisture content and tracking the rate of drying until moisture equilibrium is achieved.

The default work plan defines a process, which manages the job from initial walk through with the customer to completing the drying process. This work plan includes a series of steps or tasks, and is editable by the project manager in order to add or remove tasks within the standard, but as required by each project. Each step of the work plan contains status, person responsible, and date completed. This work plan ensures that all of the project managers address each component of the water damage loss and drying procedure, thus creating a repeatable process based on industry accepted standards.

The default plan provides what is essentially a checklist that helps to ensure a repeatable process by each project manager in the industry. The following include the steps of the default plan; each step is supported by one or more forms that have boxes that are filled in by the project manager and/or personnel in the field (at the job site), to add to the computer memory the appropriate information for the particular job. Each step of the work plan contains a current status, date completed, and who completed the step. This information is entered into the computer.
Initial walkthrough with the property owner or manager. Project manager enters information about the property owner's or property manager's water damage loss.

This includes water damage occurrence date, property manager's contact date, property inspection date, job start date, and a description/classification of the loss.

After this data entry screen is complete the water damage project is started. The project manager is now able to navigate the project, by reviewing project details, printing water damage forms, updating/reviewing the work plan, adding building images, mapping the moisture content in water damaged rooms or areas, triaging (categorizing water damaged materials into three groups) materials for drying, (discarding because of no value or an inability to dry, protection of non-damaged material, or drying materials that can be saved), entering equipment and labor charges as applied on a daily basis.
Identify and stop the source of water, remove standing water and isolate water damaged areas. Identify the individual who stopped the source of the water damage, thus holding the individual responsible for completing the task.
Review and assess the condition of room contents as to the extent of the damage
Identify wet structural materials and restrictive vapor barriers as required to identify initial conditions, and to determine the creation of a drying chamber.
Position drying equipment. Add to, remove and reposition as calculated and required during the course of the job to maximize the effectiveness of the resources applied to the project.
Establish drying standards, which will be the targets that determine when the drying job is complete. The drying standards are identified by using instruments to measure the moisture content of like materials in an undamaged area.
Add building images. This allows the project manager to upload electronic pictures (generally a jpeg file) of the water damage project, including outside pictures of the water damaged structure, the source of the water damage, inside the structure of an undamaged area, and the area where the water damage occurred.
Map the rooms in which drying is needed. Mapping consists of providing a layout of the water damage in the room. This layout is either an uploaded schematic of the room files generated by another software program, a scan of an architectural drawing, or a mapping of moisture using a room drawing program by the project manager or on scene labor created using the computer generated forms provided for the project. The moisture-mapping component has several unique features.
Map drying metrics, including outside temperature, outside relative humidity, inside temperature, inside relative humidity, moisture content of materials, and the locations of the structure and materials that need to be dried. The temperature and humidity information is generally added to the saved and mapped records each day of the water damage job. The GPP is calculated by the program and saved and mapped. The project manager may also enter comments onto these maps.
Add room details such as locations of furniture, and a description of high value materials, or materials that require specific drying procedures.
Add room images (electronic pictures), with comments and drawings superimposed on those images by the project manager. This feature allows the upload and annotation of an unlimited number of pictures including infrared scan pictures. Generally there are about four pictures per room, the pictures including an identification of water damaged areas, and the locations and types of applied equipment.
Enter equipment, labor, job activities, and travel charges on a daily basis as required to analyze and maximize the effectiveness of the drying process.
Automatically creates graphs for comparison of moisture metrics by room. The graphs include outside conditions (temperature, relative humidity, and GPP (calculated) over time of the project), inside conditions, typically measured in each room being dried (temperature, relative humidity and GPP (calculated) over time of the project), and moisture content of the water damaged material for each moisture point. These data can be gathered using handheld and operated instruments designed for measurement of moisture content, automatic remote monitoring instruments that communicate with a computer wirelessly or over a wired network, or a combination, to ensure the accuracy of the metrics. These metrics are graphed over time over the course of the drying job.
Calculate business intelligence metrics. This allows a comparison of the current water damage job to other water damage jobs. The metrics reviewed can include quantity, application of and charges for dehumidifiers, heaters, air movers, air scrubbers, labor, management, travel, and materials as one of the standards to effect comparison with other water damage restoration projects.
Print a project report, which is an aggregation of all the project information. The report is for retention of company records, for the property owner or manager as a record of what was damaged, and the restoration procedures that were applied, and for the insurance carrier that may have the responsibility for settling the loss.

The unique moisture mapping process contains several metrics that are monitored by the project manager. They are: outside temperature, outside relative humidity, outside absolute moisture GPP, inside temperature, inside relative humidity, inside GPP (for each of the water damage drying chambers). A user enters the readings for each of these metrics during the water damage remediation process, or until the target values for these metrics are reached. The outside temperature and outside relative humidity can be obtained automatically from the weather.com service, based upon the zip code where the water damage project is occurring, or it may be manually entered.

A method of real time graphing summary shows graphs of each moisture-mapped drying chamber. The metrics analyzed are metric values in the y-axis and time across the x-axis. The graphs show outside conditions where the metrics are temperature, relative humidity, and GPP. There is one graph of temperature, relative humidity, and GPP conditions per drying area. There is also one graph per drying area that displays the moisture map. The metrics are the highest moisture content of each moisture point measured. In this moisture graph, there is a line drawn parallel to the x-axis, which represents the “goal” moisture content that should be obtained. Another graph is an equipment usage chart. This measures the number and types of units of equipment used across time. The equipment measured consists of air movers, dehumidifiers, air scrubbers, and ancillary equipment used in support of drying. Labor hours are also tracked for all project personnel and graphed by worker job level hours per day. These metrics are then summarized using the extreme data to identify the gating moisture content readings defining the areas that will define the length of the project.

The business intelligence method of the invention comprises unique performance metrics, which measures the following job indicators: dehumidifiers, temporary heaters, air movers, air scrubbers, labor, management, travel, and materials. For each metric, algorithms determine the usage of these metrics within a job and compare the usage of these metrics against other jobs. These other jobs can be sorted by type of structure, office, dollar size, project manager, or other criteria particular to a contractor's business. As a result the efficiency of a particular job can be determined. The metrics are:

Equipment Analysis
Dehumidification
   Cost of dehumidification as a percent of total cost
   Air changes per hour (ACH) per total wet building volume
   Average cost per unit per day
   Pints of water removal applied per 24 hours
Air Movers
   Cost of air movers as a percent of total cost
   Air movers per linear ft. (wet areas)
   Air movers per square ft. (wet areas)
   Average cost per unit per day
Air scrubbers
   Cost of air scrubbers as a percent of total coast
   ACH per total wet building volume
   Cost per cubic foot per minute per day

Labor and Material Analysis
Labor
   Cost of labor as a percent of total cost
   Cost of labor as a percent of total personnel cost
   Cost of labor overtime as a percent of labor cost
   Cost of management as a percent of total cost
   Cost of management as a percent of personnel cost
Travel
   Cost of travel as a percent of total cost
   Cost of vehicles as a percent of travel cost
   Cost of per diem as a percent of travel cost
Materials
   Cost of materials as a percent of total cost

The report also utilizes “stop/light” color-coding, and other graphs and algorithms to show job performance. Green is within the acceptable range, yellow is deviation from the acceptable range, and red is below or above the acceptable range.

The asset management component measures the usage of equipment, vehicles, and personnel. Equipment is assigned to each drying area job by serial number. This allows accurate billing for use at the jobsite, and also provides an ability to determine utilization by each individual piece as well as by class, e.g., air movers, dehumidifiers, temporary heaters, and air scrubbers. Material used is documented for accurate billing. Labor is assigned to each job by hours assigned to that job. This allows accurate billing and analysis of utilization of personnel. These metrics are also reported by the business intelligence component, and may be selected for inclusion in the final report.

The process management system may provide the project manager, property owner, property manager, insurance adjuster, insurance carrier, other estimating system metrics, and other personnel with a collaboration system to report on vendors, networks, and insurance companies. When data for the water damage restoration project is entered on a daily basis, the program allows the water damage restoration company owner or manager, project manager, the insurance adjuster or insurance carriers, and / or the property owner and or manager to evaluate the progress being made. A series of algorithms provide an opportunity to make changes to the project in progress in a manner that maximizes the effect of the assets utilized. The criteria are based on industry standards, geographic area, type of construction, and other variables.

The metrics for use during the daily management of the job are determined through the calculation of data entered for each day of the project. These daily algorithms for analysis by day are:

### Initial Review

Assignment date vs. contract dates
More than one day

Contract date vs. job site visit and date of assessment
More than two days

Assessment date/estimate date
More than two days

### First Day Completed

Estimate date vs. mapping date
More than two days

Cost of WDR coded job items for first day is 30% or more of total cost of estimate
Estimated cost vs. actual cost of equipment, labor, materials, and travel

Dehumidifiers (D/H) plus or minus 10% of requirement for D/H for the category and class of job
From drying area description

Air Scrubbers (A/S) plus or minus 10% of requirement for A/S for the category and class ofjob
From drying area description

Air Movers (A/M) plus or minus 10% of requirement for A/M for the category and class of job
From drying area description

### Second Day Completed

Cost at the end of the second day is greater than 50% of total estimate
Estimated cost vs. actual cost of equipment, labor, materials, and travel

GPP inside is at least 20% less than GPP outside
From drying area outside conditions/inside conditions

GPP is less than 50
From inside conditions

D/H plus or minus 10% of requirement for category and class of job
From drying area description

A/S plus or minus 10% of requirement for category and class of job
From drying area description

A/M plus or minus 10% of requirement for category and class of job
From drying area description

Five worst moisture content readings 20% less than day one
From moisture content readings summary graph

### Third Day Completed

Costs of wdr coded items greater than 80% of estimate
Estimated cost vs. actual cost of equipment, labor, materials, and travel

GPP is less than 40
From inside conditions

D/H plus or minus 10% of requirement for category and class of job
From drying area description

A/S plus or minus 10% of requirement for category and class of job
From drying area description

A/M plus or minus 10% of requirement for category and class of job
From drying area description

Five worst moisture content readings 40% less than day one
From moisture content readings

### Subsequent Days Completed, as Required

Costs of wdr coded items greater than sum of the estimate divided by the number of days completed
From estimated cost vs. equipment, labor, materials, and travel greater than sum of daily costs divided by the number of days

GPP inside is less than 40
From inside conditions

D/H plus or minus 20% of requirement for category and class of job
From drying area description

A/S plus or minus 20% of requirement for category and class of job
From drying area description

A/M plus or minus 30% of requirement for category and class of job
From drying area description

Five worst moisture content readings 50% less than day one
From moisture content readings

### Final Day Completed

All equipment removed

All moisture content readings below standards

To accomplish the above daily analysis, manual data entry or automated input of data from remotely gathered and transmitted data are entered each day.

The final report component provides a detailed report of the water damage restoration project for the water damage company owner, contractor, project manager, property owner, property manager, insurance adjuster, insurance carrier, and others who may have an interest in the project. This report includes property information, customer documentation, supervisor, project narrative, general approach to water damage process, final evaluation, technical project summary which includes pictures and graphs, equipment, labor, and travel summary, detail of all the moisture mapped rooms. It also contains industry standard procedures. The report writer can also filter the report to only report on certain categories as required by individuals mentioned above.

### System Configuration

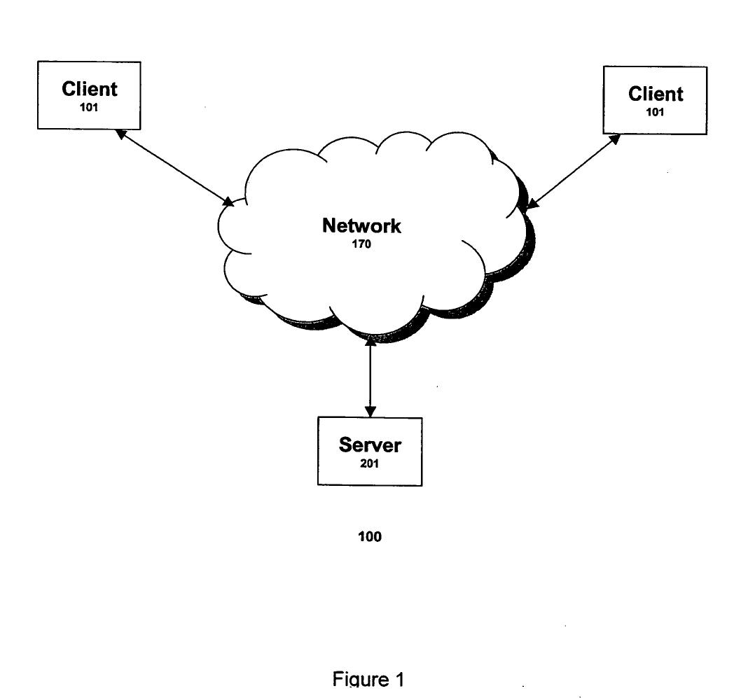

An extremely simplified block diagram of the hardware for a preferred embodiment of the invention is shown in FIG. 1, in which water drying procedure management system 100 runs in a client-server computer network. Client-server computer networks are well known in the art. In a preferred embodiment, one or more client computers 101 connect to one or more server computers 201 through a network 170, such as the Internet. In one embodiment, one or more of the client computers 101 can be hand-held wireless devices with both data input and display capabilities, similar to PDAs.

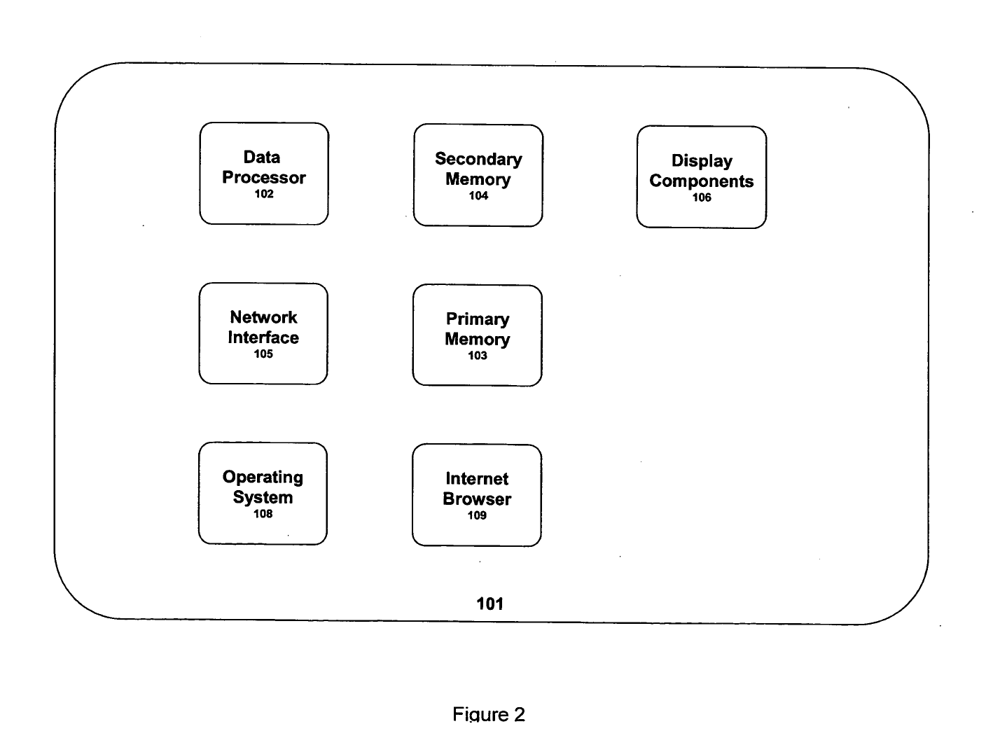

A simplified block diagram of a typical client computer is generally shown in FIG. 2. Client computer 101 may include, but is not limited to, well know components such as data processor 102; volatile and non-volatile primary memory 103; secondary memory 104 such as hard disks, floppy disks, or other removable media; network interface components 105; and display devices and corresponding drivers 106. Client computer 101 runs an operating system 108, such as the Microsoft's Windows NT operating system. In addition, Client computer 101 may run an Internet browser 109, such as Microsoft's Internet Explorer.

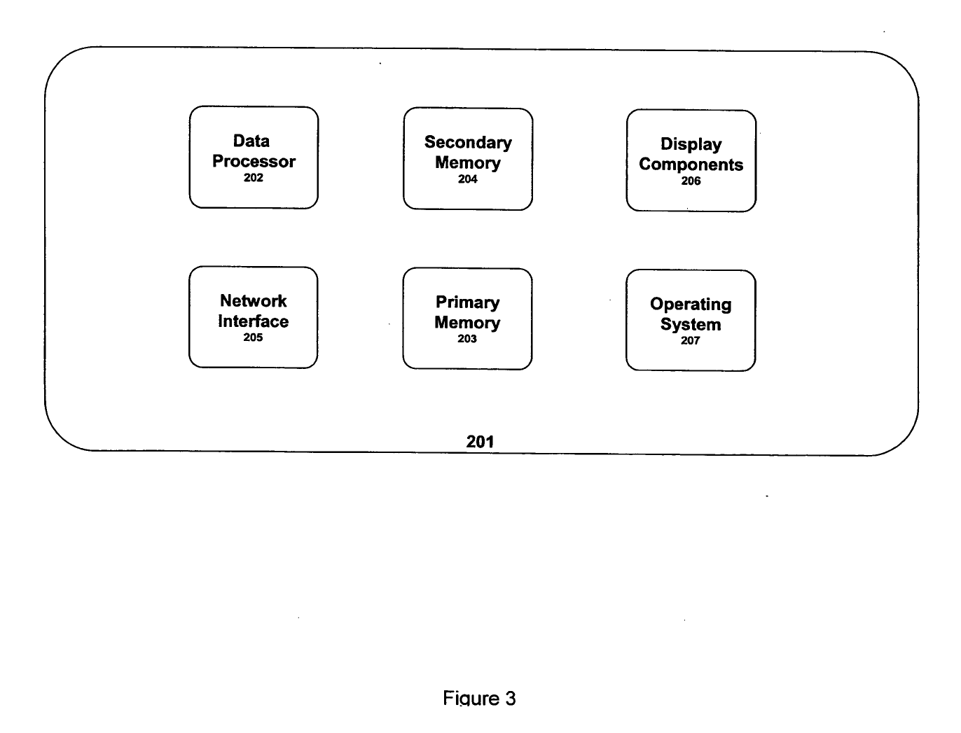

A simplified block diagram of a typical server computer is generally shown in FIG. 3. Server computer 201 includes well known components similar to those of a client computer, including data processor 202; volatile and non-volatile primary memory 203; secondary memory 204 such as hard disks, floppy disks, or other removable media; network interface components 205; and display devices and corresponding drivers 206. Server computer 201 runs an operating system 207, such as the Microsoft's Windows NT operating system.

The invention is not limited to this configuration, and in alternative embodiments, system 100 may run as a standalone application on a desktop or laptop computer, or on multiple computers connected via private or public network.

In a preferred embodiment, a web-based user interface at the client computer is used to capture and display project information. The information is typically entered by the user through forms managed by a computer program resident on the client computer. The forms are of a typical arrangement, with fill-in boxes adjacent to explanatory text. Some of the boxes may have drop-down menus.

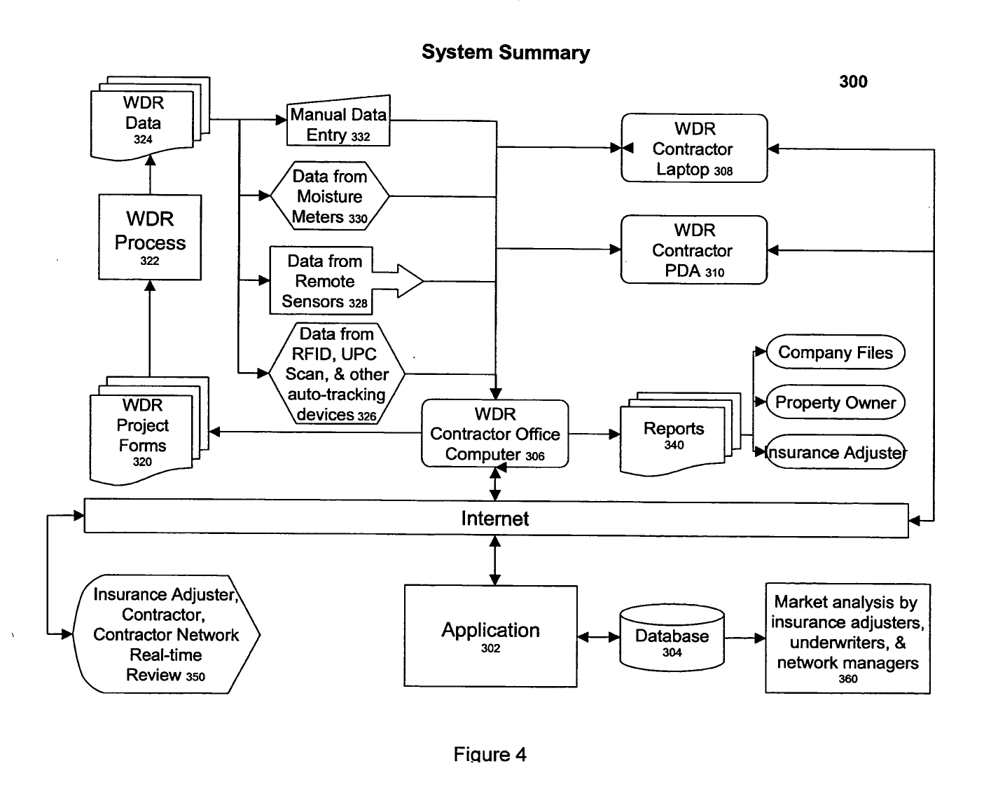

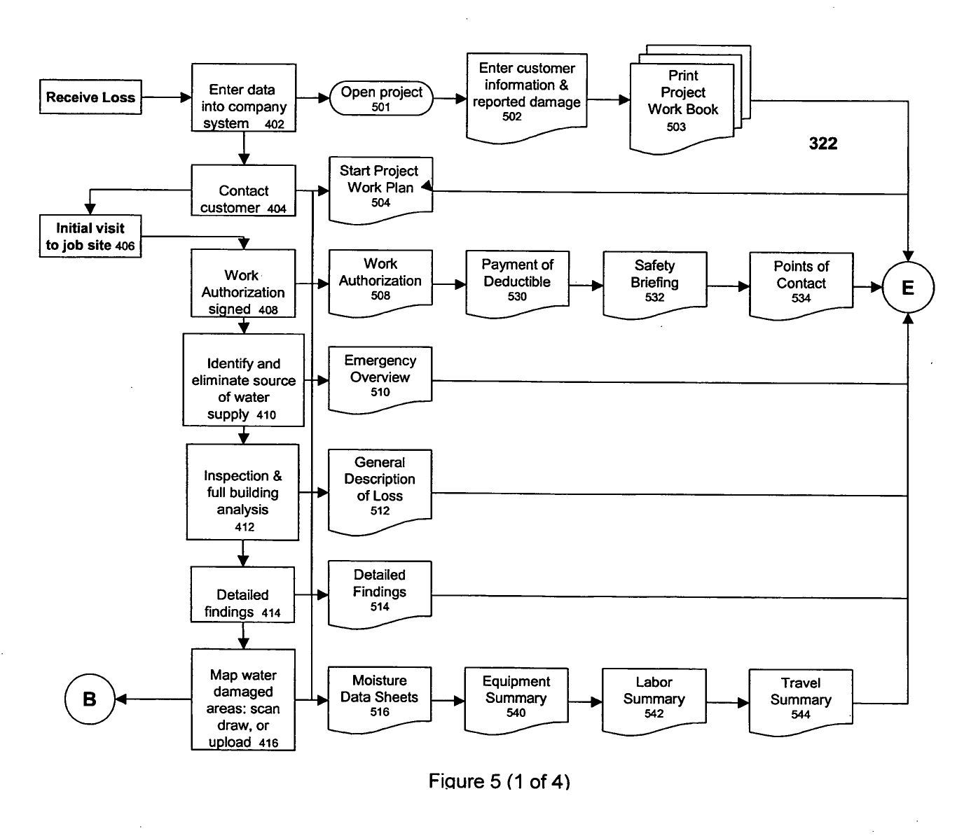

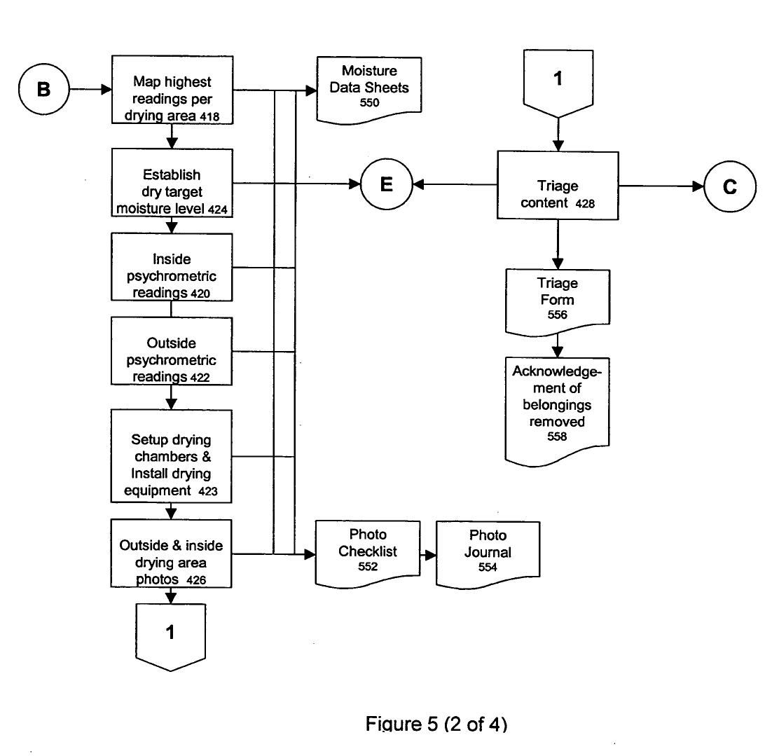

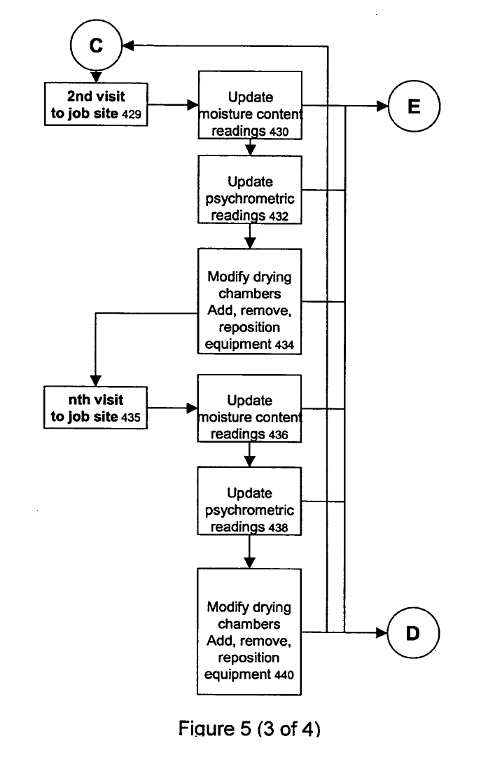

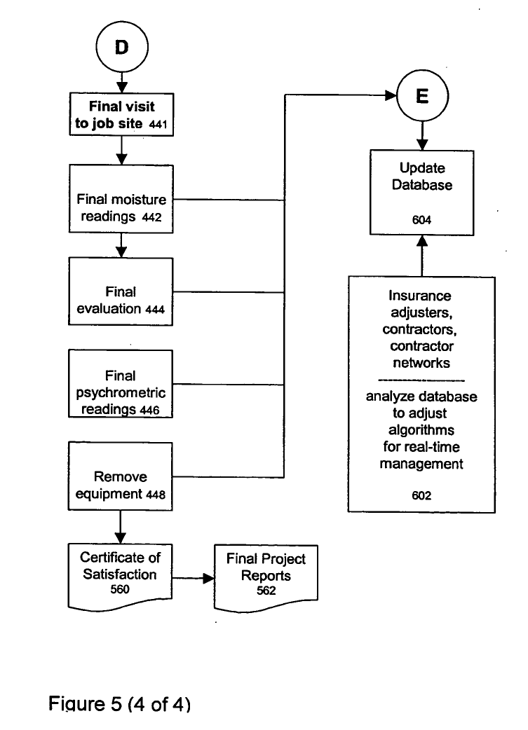

A detailed block diagram of the system of the invention is shown in FIG. 4. Application software 302 is typically resident on a server that is accessible by office computer 306, laptop 308, and PDA 310, over the internet, or perhaps a private network or the like. Typically, data from the water damage restoration (WDR) project is entered into the database by a user through computer 306, laptop 308 and/or PDA 310. Data is stored in server database 304. Data is entered on forms, either printed forms 320, or computer forms. The actual WDR process 322 is detailed in FIG. 5. In reference to FIG. 4, data 324 is entered, either by manual data entry 332 using a computer 306, 308 or 310 (based on paper forms completed on-site and entered into a computer later, and/or based on the use of computer forms) and/or entered automatically through remote sensors 328, and/or from RFID tracking or UPC-type scanning 326, and/or direct entry through a moisture meter interface 330. Reports 340 are printed as needed, typically on a daily basis, with a full project report printed after job completion. Other authorized personnel can review the data, 350 and/or analyze the data 360.

A detailed flow chart of the water damage restoration (drying) process 322 of the invention, in accordance with a preferred embodiment of the invention, is shown in FIG. 5. Upon receipt of a report of water damage (a “loss”), a project manager creates a record for a new water damage restoration project at step 402. This involves opening a new project 501, entering customer information and reported damage, step 502, and printing a project workbook (which has instructions and blank forms to document data collection over the course of the project, many of the forms shown in FIG. 5), step 503. The customer is then contacted, step 404, and an initial WDR work plan is begun, step 504. At the initial site plan visit, step 406, the customer signs a work authorization form, step 408, also including processing of deductible payment 530, a safety briefing to the customer 532, and establishing points of contact through the progression of the job 534. As part of an emergency overview procedure 510, the water source is located and terminated if possible, step 410.

The contractor next performs an inspection and full building analysis and deploys restoration equipment, step 412, as further explained elsewhere herein. Further initial work includes entering into workbook forms a general description of the loss, 512. Detailed findings from the inspection analysis 414 are entered in data forms, step 514.

Maps of water-damaged locations are created, step 416. Initial moisture data sheets 516, equipment summary 540, labor summary 542 and travel summary 544 are created. The maps include, typically, the 3-5 highest moisture readings per area being dried, step 418, with creation of moisture data sheets 550. Drying goals are established, step 424. Inside psychrometric readings 420 and outside psychrometric readings 422 are taken. Drying chambers are established, step 423. Drying chambers are typically separate rooms being dried, but moisture barriers other than interior walls may necessitate chambers that include more than or less than one room.

Photos of the outside of the building, and the inside of the building, particularly areas to be dried, are taken, step 426. These are typically images taken with a digital camera and uploaded, but the other described options are possible. The images typically included exterior and interior images. A photo checklist 552 and photo journal 554 are then created. Potentially damaged contents are triaged, step 428. A triage form 556 and a listing of belongings removed 558 are created.

At the second site visit 429, updated moisture and psychrometric readings 430, 432, are taken, and drying chambers are adjusted as necessary and equipment is changed and/ or moved based on the results, step 434. At the following visits 435, these same steps are taken, 436, 438 and 440. At what turns out to be the last site visit 441, final moisture readings and psychrometric readings are taken, 442 and 446. A final evaluation of the project is made, step 444. Equipment is removed, step 448. A certificate of customer satisfaction is printed and signed, step 560, and the final report is printed, step 562. Insurance adjusters, contractors and contractor networks can analyze the database and adjust the default algorithms described herein for real-time management, step 602. Data is entered in the database, and if the algorithms have been adjusted, the database is automatically updated to reflect such changes, step 604.

In a preferred embodiment, a system user must first be authenticated and authorized by the server through a username and password entered in a form on the client, although other forms of authentication and authorization, as known in the art, are contemplated and within the scope of the invention. After authentication and authorization, creating a new water damage restoration project requires (or allows, when fields are optional) a user to enter administrative data, including but not limited to the following fields: custom project number (in addition to or as an alternative to the project number generated by the system); company name, which is used if the customer is a company; customer contact information, including first and last name, address, and telephone and facsimile numbers; the square footage of the building and the total volume of the building in cubic feet. Also included are the job start date, the job end date, the date of the loss or damage, and the date on which the inspection was accomplished. The loss type is described and a rough estimate of the cost to accomplish the drying procedure is added. The type of water (“clean, gray or black” water) involved in the incident is added.

The following variables may include drop-down menus, or can be left as boxes to be filled in: building type, flooring type, heat source type, heating type, hot water heater type, piping type, roof style, roof type, and siding type. The dishwashing make and model and ice maker make and model can also be added.

If relevant, insurance data can be added including insurance company, insurance adjuster, policy holder, policy number and deductible amount.

Data specific for each area affected by water and needing drying is added. Typically, each room or space is identified with a text description (such as “a living room”), along with the room dimensions and square footage. The water location map is typically a two-dimensional schematic diagram of the building with the particular area highlighted, or can be a diagram of just the particular area. The types and locations of remediation equipment are indicated in the diagram. This can be accomplished with icons placed in appropriate locations and identified in the drawing.

The program uses standard industry accepted algorithms to determine the application of the number of air movers, dehumidifiers, and air scrubbers recommended for that particular area. The algorithms are:

Room offset=cubic footage of area that protrudes from the room

Room inset=cubic footage of area that intrudes on the room

Room Volume=(Total Width*Total Height*Total Length)+room offset−room inset

Necessary pints of moisture to be removed from the affected area=Room Volume/Class¹ Factor [either 1, 2, 3, or 4]

Refrigerant dehumidifiers (AHAM² pints)—

For class 1: Standard Dehumidifier divide by 100
Low Grain Refrigerant Dehumidifier divide by 100

For class 2: Standard Dehumidifier divide by 40
Low Grain Refrigerant Dehumidifier divide by 50 ¹ Classes of losses (Clean water source) Class 1: Slow rate of evaporation—Water losses that affect only part of a room or area; or losses with low-permeance/porosity materials Class 2: Fast rate of evaporation—Water losses that affect the entire room of carpet and cushion. Water has wicked up the walls less than 24 inches. There is moisture remaining in structural material. Class 3: Fastest rate of evaporation—Water may have come from overhead. Ceilings, walls, insulation, carpet, cushion, and subfloor in virtually the entire area are saturated. Class 4: Specialty drying situations—these losses involve wet materials with very low permeance/porosity Typically, there are deep pockets of saturation that normally require very low humidity.² The Association of Household Appliance Manufacturers (AHAM) tests dehumidifiers to establish their effectiveness in removing moisture for air, measured in AHAM pints/24 hours.

For class 3: Standard Dehumidifier divide by 30
Low Grain Refrigerant Dehumidifier divide by 40

For class 4: Standard Dehumidifier divide by 100
Low Grain Refrigerant Dehumidifier divide by 100

For Desiccant Dehumidifiers calculate the Cubic Feet per Minute (CFM) air changes:

Class 1 cubic feet of water damaged area divided by 60 (1 air change per hour)=CFM of Dehumidification for job

Class 2 cubic feet of water damaged area divided by 30 (2ACH)=CFM of Dehumidification for job

Class 3 cubic feet of water damaged area divided by 20 (3ACH)=CFM of Dehumidification for job

Class 4 cubic feet of water damaged area divided by 60 (1ACH)=CFM of Dehumidification for job

Once the necessary drying equipment is procured and positioned, once or more per day, the necessary interior and exterior metrics are added. The interior conditions can be determined by automated equipment left at the site that communicates over wires or wirelessly with a computer client, or can be determined manually by a technician and then entered into the proper computer form. This data is then reported in both tabular and graphical form in the final report.

The periodic moisture levels (typically including the inside temperature, relative humidity, and grains of moisture per pound of dry air) are plotted on a graph, with time on the X axis. The relevant dry standards for each measured location are also plotted as a horizontal line. This plot then gives a visual means of analyzing the progress of the drying procedure over time. When the relevant standard or standards are met, the drying procedure is considered complete.

As the job progresses, the work plan can be modified as determined by the user. When the project is complete, a project report is generated. The final step can include analyzing project data. Data analysis is further explained elsewhere.

The equipment used is tracked on a daily basis, both for technical and billing purposes. The labor use is also tracked on a daily basis for the same purposes. Travel charges and material charges are typically also tracked on a daily basis.

Although specific features of the invention are shown in some drawings and not others, this is for convenience only, as the features may be combined in other manners in accordance with the invention. Other embodiments will occur to those skilled in the art and are within the following claims.

What is claimed is:

1. A computer readable program for use in a computer to manage a drying procedure performed at a structure, the computer readable program comprising instructions to:
a) provide a graphical user interface to display data input forms that when completed record data that establishes:
i) information relating to the structure, including the locations in which drying is needed;
ii) the amount and types of drying equipment used to accomplish the drying procedure;
iii) periodic moisture content levels in the locations being dried; and
iv) the labor used in the drying procedure; and
b) save the data from step a) in a computer memory.

2. The computer readable program of claim 1 in which the data input forms when completed further record data that establishes a description of water damage and its cause.

3. The computer readable program of claim 1 in which the data input forms when completed further record data that establishes images of the structure.

4. The computer readable program of claim 3 in which the images of the structure are selected from the group of image types including electronic images, photographs, and images drawn by a user.

5. The computer readable program of claim 4 in which the electronic images include a schematic diagram, or annotation to reflect or better describe the captured information.

6. The computer readable program of claim 1 in which the data input forms when completed further record data that establishes equipment and labor charges.

7. The computer readable program of claim 1 further comprising instructions to allow a user to modify the data input forms.

8. The computer readable program of claim 1 in which the data input forms when completed further record data that establishes psychrometric atmospheric conditions outside of the structure.

9. The computer readable program of claim 8 in which the psychrometric conditions include temperature and humidity.

10. The computer readable program of claim 9 in which the psychrometric conditions further include the absolute moisture content of the air.

11. The computer readable program of claim 1 in which the data input forms when completed further record data that establishes psychrometric atmospheric conditions inside of the structure.

12. The computer readable program of claim 11 in which the psychrometric atmospheric conditions include temperature and humidity.

13. The computer readable program of claim 12 in which the psychrometric atmospheric conditions are used to calculate the absolute moisture content of air.

14. The computer readable program of claim 1 in which the moisture levels in the location being dried include the moisture content of materials as wood moisture equivalent, or as a percentage of moisture when saturated.

15. The computer readable program of claim 1 in which the types of drying equipment are selected from the types including dehumidifiers, heaters, air movers, and air scrubbers.

16. The computer readable program of claim 1 further comprising instructions for the computer to communicate over a computer network.

17. The computer readable program of claim 1 further comprising instructions to compare a completed drying procedure to another completed drying procedure.

18. The computer readable program of claim 1 further comprising instructions to compare a completed drying procedure to a standard drying procedure.

19. The computer readable program of claim 1 further comprising instructions to generate a report that includes at least the periodic moisture levels.

20. The computer readable program of claim 19 in which the report includes one or more graphs of the periodic moisture levels.

21. The computer readable program of claim 20 in which a graph of periodic moisture levels includes a standard moisture level for the location being dried.

22. The computer readable program of claim 19 in which the report further includes a relationship between the difference between outside psychrometric conditions and inside psychrometric conditions, equipment being used, the labor being used, the moisture content conditions of the damaged area, and the rate of drying.

23. The computer readable program of claim 1 further comprising instructions to print one or more of the data input forms, and allowing input to the computer of data written on the printed forms.

24. The computer readable program of claim 1 in which at least some of the data is collected automatically.

25. The computer readable program of claim 24 in which at least moisture data is collected automatically from remote sensing instruments.

26. The computer readable program of claim 24 in which data from at least some of the equipment is collected automatically.

27. The computer readable program of claim 1 further comprising instructions to analyze completed drying procedures that are in computer memory.

28. The computer readable program of claim 27 in which the analysis comprises a comparison of an actual drying procedure to prior drying procedures, based on the type of structure and/or the geographic location.

29. The computer readable program of claim 27 in which the analysis comprises a comparison of a proposed drying procedure to prior drying procedures, based on the steps taken, the types of drying equipment used and the application of drying equipment in the prior drying procedures.

30. The computer readable program of claim 1 further comprising establishing algorithms to analyze collected data, and using the algorithms to analyze data each day during the drying procedure.

31. A computer readable program for use in a computer to manage a drying procedure performed at a structure, the computer readable program comprising instructions to:
a) provide a graphical user interface to display data input forms that when completed record data that establishes:
i) information relating to the structure, including the locations in which drying is needed;
ii) the amount and types of drying equipment used to accomplish the drying procedure;
iii) periodic moisture content levels in the locations being dried;
iv) the labor used in the drying procedure;
v) annotated images of the structure;
vi) equipment and labor charges;
vii) atmospheric psychrometric conditions outside of the structure, including at least the temperature, humidity, and GPP; and
viii) atmospheric psychrometric conditions inside of the structure, including at least the temperature, humidity, and GPP;
b) save the data from step a) in a computer memory;
c) communicate over a computer network; and
d) generate a report that includes one or more graphs of periodic moisture content levels.

32. The computer readable program of claim 31 in which the report further includes a relationship between the equipment being used, the labor being used, and the moisture content levels to the drying rate.

33. A system using a computer, for managing a drying procedure performed at a structure, comprising:
a forms manager that creates a series of data input forms that when completed record data that establishes:
i) information relating to the structure, including the locations in which drying is needed;
ii) the amount and types of drying equipment used to accomplish the drying procedure;
iii) periodic moisture content levels in the locations being dried; and
iv) the labor used in the drying procedure; and
a memory in which the data that is input through the forms manager is saved.

34. The system of claim 33 further comprising a report generator that generates a report that includes at least the periodic moisture content levels.

35. The system of claim 34 in which the report includes a graph of the periodic moisture content levels.

36. The system of claim 35 in which the graph of periodic moisture content levels further includes a standard moisture level for the location being dried.
